(19) United States
(12) Patent Application Publication
(10) Pub. No.: US 2005/0120388 A1
(43) Pub. Date: Jun. 2, 2005

(54) Method, system, computer program product, storage device, set-top box and television set for selecting an interaction field

(75) Inventor: Warner Rudolph Theophile Ten Kate, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electroncs N. V., Eindhoven (NL)

(21) Appl. No.: 10/503,907

(22) PCT Filed: Jan. 29, 2003
(86) PCT No.: PCT/IB03/00272

(30) Foreign Application Priority Data
Feb. 11, 2002 (EP) 02075552.6

(51) Int. Cl. H04N 7/173; G06F 13/00; H04N 5/445; G06F 3/00; H04N 7/16

(52) U.S. Cl. 725/135; 725/53; 725/110; 725/112

(57) ABSTRACT

The navigation support through interaction fields in XML documents such as XHTML and SMIL is supported by the so-called tabindex attribute. In order to enable two dimensional navigation through the interaction fields, a method is proposed that divides the interaction fields into a plurality of sub-sets. Navigation according to one dimension navigates through the interaction fields across the plurality of sub-sets. Navigation according to the other dimension navigates through the interaction fields within a plurality of sub-sets.

The invention relates to a method of selecting an interaction field from a plurality of interaction fields, the method comprising:
navigating through the interaction fields to select the interaction field.

The invention further relates to a system to select an interaction field from a plurality of interaction fields, the system comprising:
navigation means conceived to navigate through the interaction fields to select the interaction field.

The invention further relates to a computer program product designed to perform such a method.

The invention further relates to a storage device comprising such computer program product.

The invention further relates to a set-top box and a television set comprising such a system.

An embodiment of such a method, system and computer program product is generally known from the navigation support through Extensible Markup Language (XML) based documents, referenced by the Extensible Markup Language (XML) 1.0 (Second Edition), W3C Recommendation, 6 Oct. 2000 on http://www.w3.org/TR/2000/REC-xml-20001006. Here, W3C stands for the World Wide Web Consortium. Such documents include documents written in for example the Hypertext Markup Language (HTML), see HTML 4.01 specification, W3C Recommendation 24 Dec. 1999 on http://www.w3.org/TR/html401/, the Extensible Hypertext Markup Language (XHTML), see XHTML 1.0: the Extensible HyperText Markup Language A Reformulation of HTML 4 in XML 1.0, W3C Recommendation January 2000, on http://www.w3.org/TR/xhtml1/, or the Synchronized Multimedia Integration Language (SMIL), referenced by Synchronized Multimedia Integration Language (SMIL 2.0), W3C Recommendation, 7 Aug. 2001 on http://www.w3.org/TR/2001/REC-smil20-20010807/.

SMIL has been designed to provide XML syntax for the integrated presentation of, and interaction with, multimedia content. It has also been designed to support profiling, such that applications and devices can be scaled and extended for their intended purposes. Furthermore, SMIL has been designed to be interoperable, such that its applications can operate in distributed, heterogeneous environments.

Navigation support through interaction fields comprised within an HTML-based or SMIL-based document is supported by a so-called, “tabindex” attribute, see the HTML 4.01 specification, W3C Recommendation 24 Dec. 1999 on http://www.w3.org/TR/html401/. Within this document, the “tabindex” attribute is defined in section “17.11.1 Tabbing navigation”, see http://www.w3.org/TR/html401/interact/forms.html#adef-tabindex of which the most relevant part is repeated here:
tabindex=number[CN]

This attribute specifies the position of the current element in the tabbing order for the current document. This value must be a number between 0 and 32767. User agents should ignore leading zeros.

The tabbing order defines the order in which elements will receive focus when navigated by the user via the keyboard. The tabbing order may include elements nested within other elements.

Elements that may receive focus should be navigated by user agents according to the following rules:

Those elements that support the tabindex attribute and assign a positive value to it are navigated first. Navigation proceeds from the element with the lowest tabindex value to the element with the highest value. Values need not be sequential nor must they begin with any particular value. Elements that have identical tabindex values should be navigated in the order they appear in the character stream.

Those elements that do not support the tabindex attribute or support it and assign it a value of “0” are navigated next. These elements are navigated in the order they appear in the character steam . . .

Tabbing keys. The actual key sequence that causes tabbing navigation or element activation depends on the configuration of the user agent (e.g., the “tab” key is used for navigation and the “enter” key is used to activate a selected element).

User agents may also define key sequences to navigate the tabbing order in reverse. When the end (or beginning) of the tabbing order is reached, user agents may circle back to the beginning (or end).

The previous definition of the “tabindex” value has been taken over by SMIL. SMIL introduces temporal semantics to HTML's tabindex wherein only the active fields are observed, see http://www.w3.org/TR/smil20/extended-linking.html#adef-tabindex of which the most relevant part is repeated here:
tabindex

This attribute provides the same functionality as the tabindex attribute in HTML [HTML4]. It specifies the position of the element in the tabbing order for the current document. The tabbing order defines the order in which elements will receive focus when navigated by the user via the keyboard. At any particular point in time, only elements with an active timeline are taken into account for the tabbing order. Inactive elements should be ignored for the tabbing order.

When a media object element has a tabindex attribute, then its ordered tab index is inserted in the SMIL tab index at the location specified by the media object's tabindex attribute value. This assumes the media object itself has tab indices, such as embedded HTML with tabindex attributes. This enables all link staring points in a SMIL presentation to have a place on the ordered list to be tab-keyed through, including those in embedded presentations.

Thus, the “tabindex” attribute identifies interaction fields by assigning numbers to the interaction fields by which an author can order the fields on a linear scale. A user can control focus, i.e. the selection of the active field, by hitting a TAB and SHFT-TAB key, causing the focus to move up or down to the next or previous field according to the order given by the “tabindex” values.

Usually, XML documents are displayed on devices that support mouse navigation, and a user can navigate in random order by using a pointing device like a mouse or joystick. The TAB based navigation is then an assist to the mouse based navigation.

In contrast, consumer electronic devices like set-top boxes and televisions sets usually provide arrow-based navigation, using Left/Right and Up/Down keys comprised within a remote control or within a separate keyboard. A separate OK button is often used actual for selecting an interaction field, but there is only a limited free-moving cursor available to a user. Thus when an XML document is loaded for presentation on the consumer electronic device and there are only Left/Right and Up/Down keys available to the user, the user can use these Left/Right and Up/Down keys for the two-dimensional navigation. However, since the “tabindex” attribute only describes a linear order, the keys can only be used to navigate according to one direction. Therefore, there is no benefit from the two dimensional character of the Left/Right and Up/Down keys and as a consequence either one pair of keys is disabled or both pairs of keys cause the same move in focus upon an interaction field.

It is an object of the invention to provide a method according to the preamble that benefits more from the two dimensional character of the Left/Right and Up/Down keys. In order to achieve this object, the method is characterized in that the method further comprises:
subdividing the plurality of interaction fields into a plurality of sub-sets, wherein each sub-set comprises a number of interaction fields of the plurality of interaction fields; and
navigating to select the interaction field comprises:
   navigating through the number of interaction fields across the plurality of sub-sets; and
   navigating through the number of interaction fields within a sub-set of the plurality of sub-sets.

By dividing the plurality of interaction fields into a plurality of sub-sets wherein each sub-set comprises a number of interaction fields of the plurality of interaction fields, Up/Down keys can be used to navigate across the different sub-sets and select a predefined sub-set to select the interaction field from. Then within each sub-set the Left/Right keys can be used to navigate to the interaction field that a user wants to select. It is also possible that the Left/Right keys are used for selection of the predefined sub-set and the Up/Down keys are used for selection of the interaction field within the sub-set. Hereby, two dimensional navigation is supported. A further advantage of the invention is, that it can also support three-, four-, and more-dimensional navigation. Then each dimension comprises a plurality of sub-sets across which to navigate through the number of interaction fields.

An embodiment of the method according to the invention is described in claim 2. By using a linear ordering of the interaction fields, an interaction field can be expressed mathematically in terms of the directions into which navigation is possible. For example, in the case of two dimensional navigation, when an interaction field I is defined within the following range 0≦I<2^{x+y}, then I can be expressed as
I=v×2^{y}+h
wherein 0≦v<2^{x} and 0≦h<2^{y}. As a consequence, the Left key can decrease the value of h, the Right key can increase the value of h, whereas the Up key can decrease the value of v, and the Down key can increase the value of v. Thus the two dimensional navigational directions of the Up/Down and Left/Right keys is used to navigate through the interaction fields. In the case of, for example, three dimensional navigation, I can be defined within the following range 0≦I<3^{x+y+z}, then I can be expressed as
I=d×3^{x+y}+v×3^{y}+h
wherein 0≦d<3^{z}, 0≦v<3^{x} and 0≦h<3^{y}. As a consequence and additional dimension, for example Back and Front can decrease and increase the value of d, whereas the Up, Down, Left and Right keys can update the values of v and h as previously described. The base values mentioned, i.e. 2 and 3 are meant as example, other values are also conceivable.

An embodiment of the method according to the invention is described in claim 3. By using a tag that defines the number of sub-sets, the number of interaction fields comprised within one set can be influenced. Preferably, when the interaction fields are ordered linearly, the tag can define the previously described ranges of the values of v and h. When the range of the interaction fields is defined within the language describing the document, definition of only one range of v or h can be sufficient. Those ranges can also be defined within the definition of the language itself.

An embodiment of the method according to the invention is described in claim 4. By using a further tag that defines the direction to navigate through the interaction fields, it can be determined if the values of v and or h as previously described must be preferably traversed circularly or not.

It is an object of the invention to provide a system according to the preamble that benefits more from the two dimensional character of the Left-Right and Up/Down keys. In order to achieve this object, the system is characterized in that the system further comprises
subdividing means conceived to subdivide the plurality of interaction fields into a plurality of sub-sets, each sub-set comprising a number of interaction fields of the plurality of interaction fields; and
the navigation means is conceived to:
   navigate through the number of interaction fields across the plurality of sub-sets; and
   navigate through the number of interaction fields within a sub-set of the plurality of sub-sets.

A computer program product designed to perform the method according to the invention.

A storage device comprising such computer program product according to the invention.

A set-top box comprising the system according to the invention.

A television set comprising the system according to the invention.

The invention will be described by means of embodiments illustrated by the following drawings:

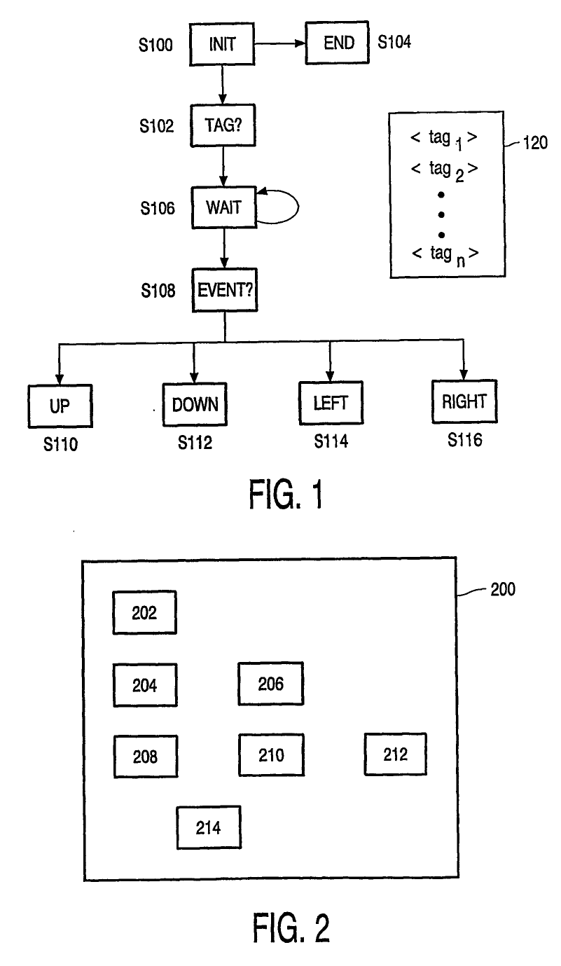

FIG. 1 illustrates the main steps of the method according to the invention;

FIG. 2 illustrates a visual layout of a screen comprising user selectable fields;

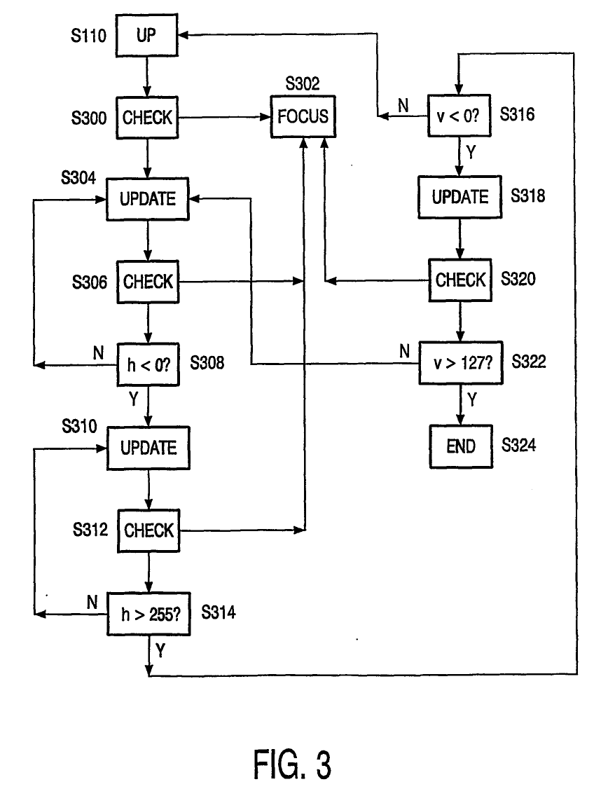

FIG. 3 illustrates the main steps of the method according to the invention in case of an “Up” event;

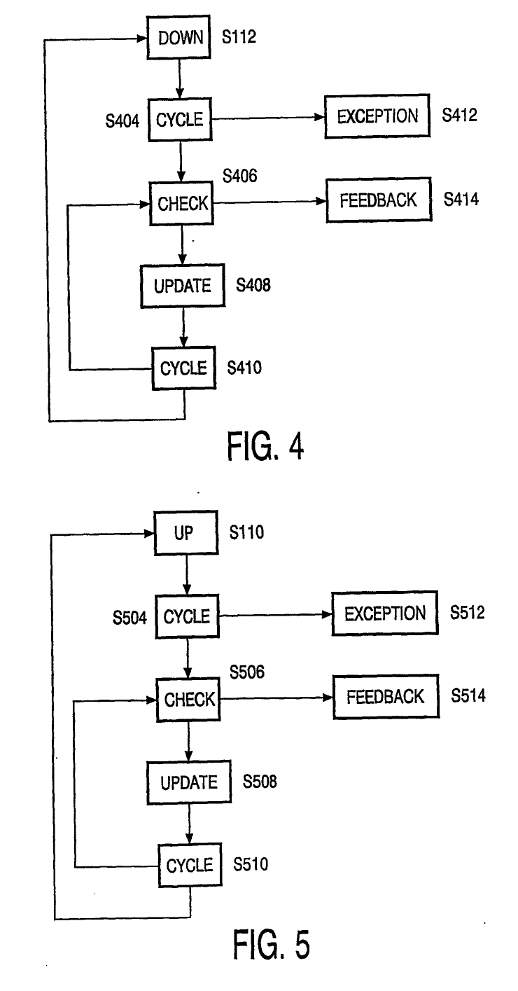

FIG. 4 illustrates a further embodiment of the method according to the invention in case of an “Up” event;

FIG. 5 illustrates the main steps of the method according to the invention in case of a “Down” event;

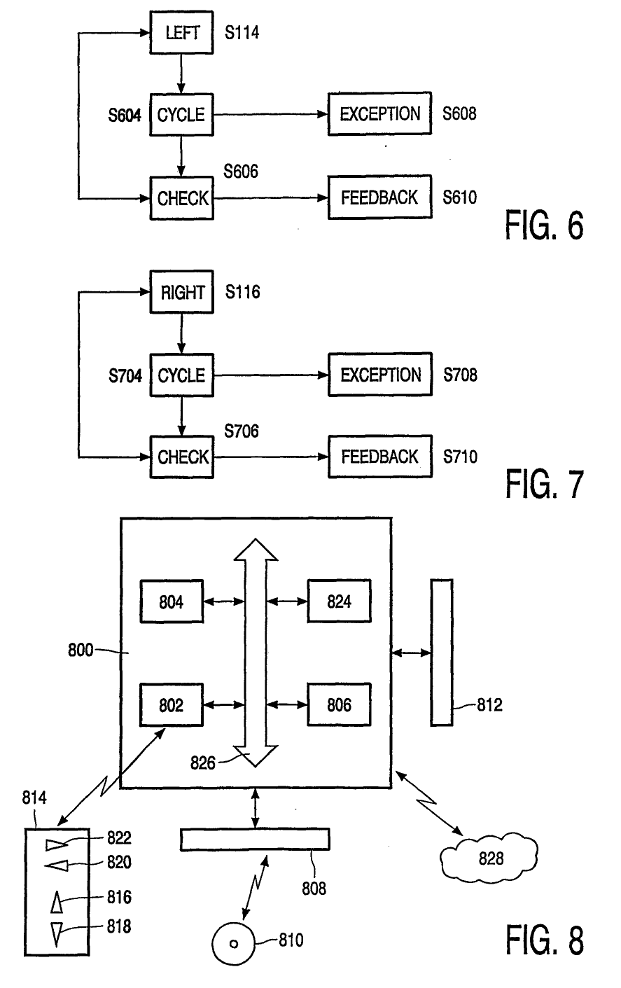

FIG. 6 illustrates the main steps of the method according to the invention in case of a “Left” event;

FIG. 7 illustrates the main steps of the method according to the invention in case of a “Right” event;

FIG. 8 illustrates the main parts of a system according to the invention;

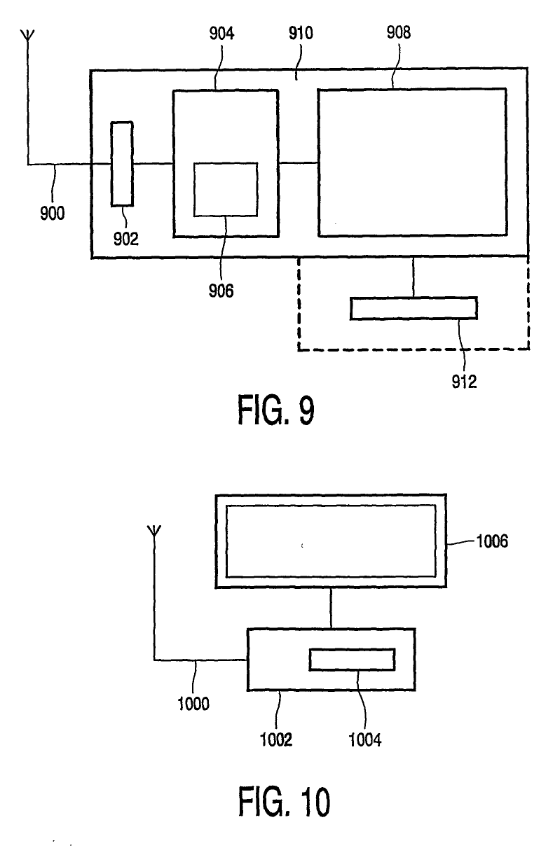

FIG. 9 illustrates a television set in a schematic way that comprises an embodiment of the system according to the invention;

FIG. 10 illustrates a set-top box in a schematic way that comprises an embodiment of the system according to the invention.

FIG. 1 illustrates the main steps of the method according to the invention. Here step S100 is an initialization step. During this step a SMIL document 120 or, for example an HTML, an XML or interactive media document, is received, parsed and displayed onto an appropriate displaying device like a television screen or a screen of a personal computer. When the document declares the “tabindex” attribute as defined within HTML 4.0 or the SMIL specification, the method proceeds to step S102. When the document does not declare the “tabindex” attribute or another attribute which provides the same semantics as the “tabindex” attribute, the method ends to step S104. Alternatively, the tabindex can be set to a default value, causing the algorithm to continue in stead of ending. As previously described, the current definition, i.e. the HTML and SMIL definition, of “tabindex” defines “tabindex” as a 15 bit value that ranges from 0 to 32767: 0≦tabindex≦32767. Because of this linear ordering, the value “tabindex” is therefore divided into a number of ranges, for example 2 ranges: one of 7 bits and another of 8 bits. Within S102 it is checked if there's a special element 122 present within the document that declares the border position between these two ranges. When the special element or attribute is present, this attribute is read and the value of the attribute is used to determine the ranges. For example: an element or attribute
<tabIndexBorder lower=“5”/>
declares the border to be at 5 bits. Thus h ranges over 5 bits and v ranges of 15=5=10 bits. When the special element or attribute is not present, a default value is used that divides the value “tabindex” into a range of 8 bits and a range of 7 bits. This default value can also be defined within a generally agreed document. Furthermore, it is checked if there's an other special element 124 present that declares if the values of h and v are to be traversed circularly as described below. When the special element or attribute is present, this attribute is read and the value of the attribute is used to determine if the values of h and v are to be traversed circularly. For example an element or attribute
<circularValue v=“yes” h=“no”/>
declares that the value of v is to be traversed circularly and the value of h is not to be traversed circularly.

Assume that the value of “tabindex” is divided into a range of 8 bits and a range of 7 bits. Then the value can be calculated as follows:
tabindex=v×256+h

where 0≦v≦127 and 0≦h≦255. Thus the value of “tabindex” is divided into a plurality of consecutive sets as described within the following Table 1:

TABLE 1

| Value of ν | Value range of tabindex |
|---|---|
| 0 | 0 ≦ tabindex < 256 |
| 1 | 256 ≦ tabindex < 512 |
| 2 | 512 ≦ tabindex < 768 |
| . | . |
| . | . |
| . | . |
| 127 | 32512 ≦ tabindex < 32768 |

As illustrated within Table 1, the values of tabindex within the sub-sets are preferably ordered such that the values within a sub-set are consecutive and no value is comprised within more than one sub-set. The interaction field with the lowest tabindex value is given the initial focus. It is also possible that the interaction field with the highest tabindex value or with a randomly chosen tabindex value is given the initial focus, or the lowest tabindex of the element that is currently active or visible on the screen, etc. Next, the method proceeds to step S106 where it waits until user input is detected. User input can be received from a remote control that supports the Up/Down and Left/Right events. When one of these events is received it is checked within a next step S108 which event is actually received. In case the event “Up” is received step S110 is performed, in case the event “Down” is received step S112 is performed, in case the event “Left” is received step S114 is performed and in case the event “Right” is received step S116 is performed. These steps will be more elaborately described below.

As defined within the definition of tabindex for a SMIL presentation, the ordered tabindex of a media object element is inserted in the SMIL tabindex at the location specified by the media object's tabindex attribute value. This can be the case when, for example, the SMIL presentation is a SMIL document presented on a Digital Versatile Disk (DVD) player and the media object element is a HTML document. In this case, the parent is the SMIL document and the child is the HTML document. As a consequence of the SMIL definition of the tabindex, the tabindex of both the parent and child document declare a single point within the parent document that can be reached through both one and 2 dimensional navigation. If this single point is reached, the child document takes over calculation of the tabindex. Then as a further embodiment of the invention, the tabindex of the parent document, tabindex₁ can be defined as:
tabindex₁=v₁×2^{y}^{₁}+h₁
And the tabindex of the child document, tabindex₂ can be defined as:
tabindex₂=v₂×2^{y}^{₂}+h₂
These definitions of the tabindex values then can lead to the following calculation of the value of tabindex:
if navigation occurs within the parent document: tabindex=tabindex₁
if navigation occurs within the child document: tabindex=tabindex₁×2^{x}^{₂}^{+y}^{₂}+tabindex₂
   wherein two dimensional navigation within the child document causes v₂ and h₂ to change and one dimensional navigation within the child document causes h₁ and h₂ to change. Other combinations of changes of v1, h1, v2, h2 providing alternative ways to navigate through the documents are also conceivable. Thus, these calculations of the value of tabindex can be considered as a mapping from a two dimensional navigation space, i.e. Up, Down, Left and Right, to a more than two dimensional navigation space, i.e. 3-, 4-, or m-dimensional navigation space. Changing the values of v and h in this embodiment corresponds to changing the values of v and h within the embodiments as described below as a result of causing an Up, Down, Left or Right event Including more dimensions is also conceivable.

In general, the calculation of the value of tabindex can reflect the number of dimensions concerned. For example, when three dimensional navigation is concerned, which can be the case when in addition to the Up, Down, Left, Right events, there are Front and Back events, the value of tabindex can be calculated according to the following formula:
tabindex=d×3^{x+y}+v×3^{y}+h
wherein tabindex is within the following range and 0≦d<3^{z}, 0≦v<3^{x} and 0≦h<3^{y}. Updating the values of d, v, and h is then analogously to updating the values of v and h as described within the corresponding embodiments.

FIG. 2 illustrates a visual layout of a screen comprising user selectable fields. Here, 200 is a screen, for example a television screen, a screen of a personal digital assistant or the like. 202, 204, 206, 208, 210, 212 and 214 are fields that can be selected by a user. There are no other user selectable fields within this example. These fields are identified by the values of “tabindex” as described in the following table:

TABLE 2

| Field | Tabindex |
|---|---|
| 202 | 128 |
| 204 | 256 |
| 206 | 500 |
| 208 | 600 |
| 210 | 601 |
| 212 | 767 |
| 214 | 1030 |

As can be derived from Table 1, field 202 is within the set for which v=0; fields 204 and 206 are within the set for which v=1; fields 208, 210, and 212 are within the set for which v=2; and 214 is within the set for which v=4. Note that there is no field available for v=3 within this example.

FIG. 3 illustrates an embodiment of the main steps of the method according to the invention in case of an “Up” event. In case of an “Up” event, which means that a user pressed for example an “Up” button, like an arrow key, present on a remote control or present on a conventional alphanumeric keyboard, the method will first search the sets as described within Table 1 for a valid v holding the set containing the value of “tabindex”. Assume that a randomly chosen field is selected initially. For example, field 206 is selected and tabindex=500, thus v=1, and h=244. In the remainder of the current embodiment, these values will be referred to as the start values. As previously described, the method according to the invention proceeds to step S110 as illustrated within FIG. 1 upon receipt of an “Up” event. Within this step, the value of v is decreased by 1, i.e. v=1−1=0, and the value of h is set to its start value, i.e. h=244.

Within the next step S300, it is checked if there is an interaction field that corresponds with the new tabindex value: tabindex=0*256+244=244. When there is a selectable interaction field available, the method proceeds to step S302. When there is no selectable interaction field available, the method proceeds to step S304.

Within step S302 the selectable interaction field receives the user focus. Different visual feedback to the user can be given to indicate that an interaction field receives the user focus. For example, by highlighting the interaction field or by emphasizing the interaction field through a border line etc. An other feedback can be by means of an audible signal to the user.

Within step S304, the value of h is decreased by 1, i.e. h=244−1=243.

Within the next step, S306, it is checked if there is an interaction field that corresponds with the new tabindex value: tabindex=0*256+243 =243. When there is a selectable interaction field available, the method proceeds to step S302. When there is no selectable interaction field available, the method proceeds to step S308.

Within step S308, it is checked if the value of h is less than 0. If the value of h is greater than or equal to 0, the method proceeds back to step S304. This way all values of h are traversed that are smaller than the start value of h, i.e. 244 of the start tabindex, i.e. 500 for the new value of v, i.e. 0. If the value of h is less than 0, the method proceeds to step S310.

Within step S310, the value of h is increased by 1. In the case that this step is performed for the first time, the value of h is set to equal its start value, i.e. 244, thus the new value of h becomes: h=244+1=245 in this case.

Within the next step, S312 it is checked if there is an interaction field that corresponds with the new tabindex value: tabindex=0*256+245=245. When there is a selectable interaction field available, the method proceeds to step S302. When there is no selectable interaction field available, the method proceeds to step S314.

Within step S314, it is checked if the value of h is greater than 255. If the value of h is less than or equal to 255, the method proceeds back to step S310. This way all values of h are traversed that are greater than the start value of h, i.e. 244 of the start tabindex, i.e. 500 for the new value of v, i.e. 0. If the value of h is greater than 255, the method proceeds to step S316.

Within step S316, it is checked if the value of v is smaller than its smallest value, i.e. 0, or the value of v greater than the start value of v. If the value of v is greater than or equal to 0 and the value of v is smaller than or equal to the start value of v, the method proceeds back to step S110. This way all values of v are traversed that are smaller than the start value of v, i.e. 1 of the start tabindex, i.e. 500. If the value of v is smaller than 0 or the value of v is greater than the start value of v, the method proceeds to step S318.

Within step S318, the value of v is increased by 1, starting from the start value of v and h is set to its start value. Thus the new value of v becomes: v=1+1=2 and the new value of h becomes h=244.

Within the next step, S320, it is checked if there is an interaction field that corresponds with the new tabindex value: tabindex=2*256+244=757. When there is a selectable interaction field available, the method proceeds to step S302. When there is no selectable interaction field available, the method proceeds to step S322.

Within step S322, it is checked if the value of v is greater than 127. If the value of v is smaller than or equal to 127, the method proceeds back to step S304. This way all values of v are traversed that are greater than the start value of v. If the value of v is greater than 127, there is no interaction field available that can be selected other than the interaction field that was selected from the start and the method ends within step S324.

Within step S324 exception handling is performed because there's no other field available to select than the selected field from which the “Up” button was selected. During this exception handling the user receives an audible signal or another signal to indicate that there's no other selectable field available. Other exception handling techniques can also be used.

FIG. 4 illustrates another embodiment of the main steps of the method according to the invention in case of an “Up” event. Within this embodiment the values of v and h are traversed circularly. This means that the value of v is set to its largest value if it becomes smaller than its smallest value. For the previous example, the value of v is set to 127, as the next value to traverse after the value v=0 has been traversed. The value of v is set to its smallest value if it becomes greater than its highest value. Thus the value of v is set to 0, if the next value to traverse after the value v=127 has been traversed. The same holds for the value of h.

As previously described, the method according to the invention proceeds to step S112 as illustrated within FIG. 1 upon receipt of a “Down” event. Assume that a randomly chosen field is selected initially, for example field 210 of FIG. 2 is selected. Then tabindex=601, thus v=2 and h=89.

Within step S112 the value of v is increased by 1, i.e. v=3.

Within the next step, S404 it is checked if all values of v have been traversed. When this is the case, the method proceeds to step S412. When not all values of v have been traversed, the method proceeds to step S406.

Within step S412 exception handling is performed because there's no other field available to select than the currently selected field from which the “Up” button was selected. During this exception handling the user receives an audible signal or another signal to indicate that there's no other selectable field available. Other exception handling techniques can also be used.

Within step S406, it is checked if for the new value of tabindex, i.e. tabindex=3*256+89=857 there is a selectable field available. When there is a selectable field available with this value, the method proceeds to step S414. When there is no selectable field available, the method proceeds to step S408.

Within step S414, the user receives appropriate feedback that indicates the newly selected field. For example by highlighting this newly selected field. However, within the current example, there is no field identified by this tabindex.

Within step S408, the value of h is increased to search for a field within the set identified by v=3. Instead of incrementing the value of h in a circular way as previously described, other implementations, like searching for the closest value of h are also possible.

Next, within step S410 it is checked if all values of h have been traversed without finding a selectable field. If not all values of h have been traversed the method proceeds to step S406. If all values of h have been traversed the method proceeds back to step S112.

Within step S406, it is checked if for the new value of tabindex there is a selectable field available. Within the current example there is no selectable field available for v=3, thus all values of h will be traversed and the method proceeds to step S112, within which the value of v is increased.

Within step S112, v is set to 4 and the new value of tabindex equals 4*256+89=1113. Proceeding the method as previously described leads to selecting field 214, see FIG. 2, with tabindex value equal to 1030.

FIG. 5 illustrates the main steps of the method according to the invention in case of an “Up” event. In case of an “Up” event, which means that a user pressed for example an “Up” button present on a remote control or present on a conventional alphanumeric keyboard, the method according to the invention proceeds to step S110. Within this embodiment the values of v and h are traversed circularly. Analogous implementations in the case that v and h are not traversed circularly can be derived from the embodiment as described within FIG. 3.

Within this step S110, the value of v is decreased. In the current example, the value of v is decreased to 1. A new selectable field is searched that is identified with tabindex equal to 1*256+89=345. The further steps S504, S506, S508, S510, S512, S514 correspond to the steps S404, S406, S408, S410, S412 and S414 as previously described.

Instead of increasing h as described in case of an “Up” and “Down” event it is also possible to decrease h or perform a combination of both.

FIG. 6 illustrates the main steps of the method according to the invention in case of a “Left” event. In case of an “Left” event, which means that a user pressed for example an “Left” button present on a remote control or present on a conventional alphanumeric keyboard, the method according to the invention proceeds to step S114. Within this embodiment the value of h is traversed circularly.

Within this step S114 the value of h is decreased. For the current example h is decreased to 88.

Within the next step S604 it is first checked if all values of h for the current value of v have been traversed. If not all values of h for the current value of v have been traversed, the method proceeds to step S606. If all values of h for the current value of v have been traversed, the method proceeds to step S608.

Within step S606 it is checked if there's a field identified by the new value of tabindex: 2*256+88=600. Within the current example, such a field 208, see FIG. 2, exists and the method proceeds to step S610 wherein an appropriate feedback to the user of selecting this field 208 is given as also previously described. If there's no field identified by tabindex equal to 600, the method proceeds to step S114.

Within step S608 exception handling is performed as previously described.

Within another implementation it is also possible to proceed to step S112, see FIG. 4 or S110, see FIG. 5 and further proceed as described in case of a “Down” event or an “Up” event respectively.

Within a further implementation, the value of h is not traversed circularly and the steps as previously described are changed analogue to the description of an embodiment of the method within FIG. 3.

FIG. 7 illustrates the main steps of the method according to the invention in case of a “Right” event. In case of an “Right” event, which means that a user pressed for example an “Right” button present on a remote control or present on a conventional alphanumeric keyboard, the method according to the invention proceeds to step S116. Within this embodiment the value of h is traversed circularly.

Within step S116, the value of h is increased. For the current example h is increased to 90.

Within the next step S704 it is first checked if all values of h for the current value of v have been traversed. If not all values of h for the current value of v have been traversed, the method proceeds to step S706. If all values of h have been traversed, the method proceeds to step S708.

Within step S708, exception handling is performed as previously described.

Within step S706, it is checked if there's a field identified by the new value of tabindex: 2*256+90=602. Within the current example, there's no field identified by this value of tabindex and the method proceeds to step S116. This loop proceeds until tabindex equals 767 that identifies field 212, see FIG. 2.

Then the method proceeds to step S710 from step S706.

Within step S710, an appropriate feedback to the user of selecting this field 212 is given as also previously described.

Within another implementation it is also possible to proceed to step S110, see FIG. 5 or S112, see FIG. 4 and further proceed as described in case of an “Up” event or a “Down” event respectively.

Within yet a further implementation of the 2D navigation of the current invention, the increment and decrement values for each tabindex are declared separately. For example, consider the following layout of elements with their respective tabindices:

| | | |
|---|---|---|
| No element | Element: X01 | No element |
| | tabindex: 01 | |
| Element: X10 | No element | Element: X12 |
| tabindex: 10 | | tabindex: 12 |
| No element | Element: X21 | No element |
| | tabindex: 21 | |

The increment and decrement per tabindex for each direction, i.e. horizontal and vertical are declared within the document. For example for element X01 with tabindex=01, the declaration is as follows:
<element tabindex=“01” left=“0” right=“9” up=“0” down=“20”../>

Now, starting in element X01 with tabindex=01, an event “Left”, or “Up” does not result in a change of the focus. The event “Down” results in a change of the focus to element X21 with tabindex=21 and the event “Right” results in a change of the focus to element X10 with tabindex=10. Thus, the next selected tabindex value, tabindex_next, can be calculated as follows:
tabindex_next=tabindex+vd*Cdown+vu*Cup+h1*Cleft+hr*Cright
wherein the value of vd is set to 1 in the case of an down event and is set to 0 in the case of an other event (up, left, right). The value of vu is set to 1 by an up event and is set to 0 in the case of an other event, the value of h1 is set to 1 by a left event and is set to 0 in the case of an other event, and the value of hr is set to 1 in the case of an right event and is set to 0 in the case of an other event. The values Cdown, Cup, Cleft, Cright are set to the values of the attributes down, up, left, right respectively.

Then starting from element X01 and upon receipt of a “Down” event the tabindex of the next selected element, tabindex_next is calculated as follows:
tabindex_next=01+1*20+0*0+0*0+0*9=01+20=21.

In the case of parent and child documents, the left, right, up and down offset values can for example hold for the complete child document giving the child document the opportunity to overrule the parent document when needed.

In stead of using offset values, for example absolute values can be used, such that for example a “down”=21 event will always result in selecting a next tabindex value with tabindex equal to 21 or results in searching for the tabindex with its value closest to 21.

Within an other implementation, the next tabindex, tabindex_next can for example also be calculated by for example calculating the smallest difference between the “h” values and between the “v” values of the different elements:
tabindex_next is that value that minimizes:
   \sqrt{(h_tabindex_next−h_tabindex)²+(v_tabindex_next−v_tabindex)²}
   or that minimizes the absolute values of the differences between the “h” and “v” values:
   abs(h_tabindex_next−h_tabindex)+abs(v_tabindex_next−v_tabindex)
   wherein h_tabindex_next is the “h” value of the next selected tabindex, h_tabindex is the “h” value of the currently selected tabindex, v_tabindex_next is the “v” value of the next selected tabindex, and v_tabindex is the “v” value of the currently selected tabindex;

Many other variations in calculating the next selected tabindex value are also conceivable such that the next selected tabindex value corresponds to an expected behaviour of the corresponding events.

If, in the described implementations, no element corresponds to the calculated new tabindex value, an alternative element can be selected. Preferably this is an element of which the tabindex value is closest to the newly calculated tabindex value. First increasing the “h” value and then the “v” value (or the other way around) can for example calculate the closest tabindex value. Here, several alternative calculations are possible, without departing from the concept of the invention.

The mentioned implementations can also be applied to, for example 8 key navigation, in which case more dimensions must be added to the calculation of the tabindex.

Within a further implementation, the value of h is not traversed circularly and the steps as previously described are changed analogue to the description of an embodiment of the method within FIG. 3.

The order in the described embodiments of the method of the current invention is not mandatory, a person skilled in the art may change the order of steps or perform steps concurrently using threading models, multi-processor systems or multiple processes without departing from the concept as intended by the current invention. Furthermore, subdividing the range of “tabindex” into a plurality of sub-ranges can enable navigation according to more than two dimensions too and enables backwards compatibility with one dimensional (1D) navigation.

FIG. 8 illustrates the main parts of a system according to the invention. The system comprises memories 802, 804, and 824. These memories are connected to each other via software bus 826. Memory 802 comprises computer readable code 830, designed to receive a signal. This signal is translated by the computer readable code 830 when executed into an appropriate event like “Up”, “Down”, “Left” or “Right”. These events indicate a desired navigation through interaction fields, as for example illustrated within FIG. 2. Memory 804 comprises computer readable code 832 that is designed to divide the range of “tabindex” into a plurality of sub-ranges as previously described. Furthermore, the computer readable code 830 comprised within memory 802 is designed to navigate across the ranges in case of an “Up” or “Down” event and is designed to navigate within a range in case of a “Left” or “Right” event. It is also conceivable that other navigational directions are chosen to navigate across or within a value range of “tabindex”. The system also comprises a processor 806 that is connected to the software bus 826 and can execute the computer readable code comprised within the memories. A general purpose memory 824 is comprised within the system that comprises computer readable code designed to signal the correct and in-correct selection of an interaction field to a user and is designed to receive a document from the internet 828 that is connected to the system 800. The document can also be received from a storage device or another information carrier. The general purpose memory 824 comprises further computer readable code designed to represent the document onto screen 812 that is connected to the system. The “Up”, “Down”, “Left” and “Right” signals are received from a remote control 814. The remote control comprises selectable fields 816, 818, 820, and 822. The remote control 814 can also comprise more fields like an “OK” field, not shown, that can be used by a user to confirm a selection. When a user selects field 816, an “Up” signal is transferred to the system 800. In the case that a user selects fields 818, 820 or 822, the signal “Down”, “Left” and “Right” respectively is transferred to the system 800. The system 800 can, optionally, comprise the remote control 814 or the system 800 can provide the functionality comprised by the remote control 814. The signal is transferred wireless via infra red, but other protocols like blue tooth are also possible. The signal can also be transferred wired, in which case the remote control 814 is physically connected to the system 800. It is also possible that more than one remote controls are connected to the system 800 simultaneously, for example by using an internet connection. In this case both remote controls can navigate through the interaction fields. The computer readable code can also be updated from a storage device 810 that comprises a computer program product 834 designed to perform the method according to the invention. The storage device is read by a suitable reading device, for example a CD reader 808 that is connected to the system 800. The system can be realized in both hardware and software or any other standard architecture able to operate software.

FIG. 9 illustrates a television set 910 in a schematic way that comprises an embodiment of the system according to the invention. Here an antenna, 900 receives a television signal. Any device able to receive or reproduce a television signal like, for example, a satellite dish, cable, storage device, internet, or Ethernet can also replace the antenna 900. A receiver, 902 receives an SMIL or HTML based document that is received together with or separate from the television signal. Besides the receiver 902, the television set contains a programmable component, 904, for example a programmable integrated circuit. This programmable component contains a system according to the invention 906. A television screen 908 shows the document that is received by the receiver 902 and is processed by the programmable component 904. The television set 910 can, optionally, comprise or be connected to a DVD player 912.

FIG. 10 illustrates, in a schematic way, the most important parts of a set-top box that comprises an embodiment of the system according to the invention. Here, an antenna 1000 receives a television signal. The antenna may also be for example a satellite dish, cable, storage device, internet, Ethernet or any other device able to receive a television signal. A set-top box 1002, receives the signal. The signal may be for example digital. Besides the usual parts that are contained in a set-top box, but are not shown here, the set-top box contains a system according to the invention 1004. An SMIL or HTML based document that is received together with the television signal or separate from the television signal is shown on a television set 1006 that is connected to the set-top box 1002.

1. A method of selecting an interaction field from a plurality of interaction fields, the method comprising:
navigating through the interaction fields to select the interaction field characterized in that the method further comprises:
subdividing the plurality of interaction fields into a plurality of sub-sets, wherein each subset comprises a number of interaction fields of the plurality of interaction fields; and
navigating to select the interaction field comprises:
navigating through the number of interaction fields across the plurality of sub-sets; and
navigating through the number of interaction fields within a sub-set of the plurality of sub-sets.

2. A method of selecting an interaction field according to claim 1, wherein a ordering of the plurality of interaction fields is linear.

3. A method of selecting an interaction field according to claim 1, wherein a first predefined tag indicates a number of sub-sets into which to subdivide the plurality of interaction fields.

4. A method of selecting an interaction field according to claim 1, wherein a second predefined tag determines a direction of navigating to select the interaction field.

5. A system (800) to select an interaction field from a plurality of interaction fields, the system comprising:
navigation means (830) conceived to navigate through the interaction fields to select the interaction field characterized in that the system further comprises
subdividing means (832) conceived to subdivide the plurality of interaction fields into a plurality of sub-sets, each sub-set comprising a number of interaction fields of the plurality of interaction fields; and
the navigation means (830) is conceived to:
navigate through the number of interaction fields across the plurality of sub-sets; and
navigate through the number of interaction fields within a sub-set of the plurality of sub-sets.

6. A computer program product (834) designed to perform the method according to claim 1.

7. A storage device (810) comprising the computer program product (834) according to claim 5.

8. A set-top box (902) comprising the system (800) to select an interaction field according to claim 4.

9. A television set (810) comprising the system (800) to select an interaction field according to claim 4.

10. A document (120) comprising a first predefined tag according to claim 3.

11. A document (120) comprising a second predefined tag according to claim 4.
